(19) United States
(12) Patent Application Publication
(10) Pub. No.: US 2022/0181629 A1
(43) Pub. Date: Jun. 9, 2022

(54) ELASTIC BINDING POLYMERS FOR ELECTROCHEMICAL CELLS

(71) Applicant: GM GLOBAL TECHNOLOGY OPERATIONS LLC, Detroit, MI (US)

(72) Inventors: Yong Lu, Shanghai (CN); Zhe Li, Shanghai (CN); Meiyuan Wu, Shanghai (CN); Haijing Liu, Shanghai (CN)

(73) Assignee: GM GLOBAL TECHNOLOGY OPERATIONS LLC, Detroit, MI (US)

(21) Appl. No.: 17/542,147

(22) Filed: Dec. 3, 2021

(30) Foreign Application Priority Data
Dec. 4, 2020 (CN) 202011398482.2

(51) Int. Cl. H01M 4/62

(52) U.S. Cl. CPC H01M 4/622; H01M 4/626

(57) ABSTRACT

The present disclosure relates to an electrochemical cell having an elastic binding polymer that improves long-term performance of the electrochemical cell, particularly when the electrochemical cell includes an electroactive material that undergoes volumetric expansion and contraction during cycling of the electrochemical cell (such as, silicon-containing electroactive materials). The electrochemical cell can include the elastic binding polymer as an electrode additive and/or a coating layer disposed adjacent to an exposed surface of an electrode that includes an electroactive material that undergoes volumetric expansion and contraction and/or a gel layer disposed adjacent to an electrode that includes an electroactive material that undergoes volumetric expansion and contraction. The elastic binding polymer may include one or more alginates or alginate derivatives and at least one crosslinker.

### CROSS-REFERENCE TO RELATED APPLICATIONS

This application claims the benefit and priority of Chinese Patent Application No. 202011398482.2, filed Dec. 4, 2020. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions and electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

Many different materials may be used to create components for a lithium ion battery. For example, positive electrode materials for lithium batteries typically comprise an electroactive material which can be intercalated with lithium ions, such as lithium-transition metal oxides or mixed oxides, for example including LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or one or more phosphate compounds, for example including lithium iron phosphate or mixed lithium manganese-iron phosphate. The negative electrode typically includes a lithium insertion material or an alloy host material. For example, typical electroactive materials for forming an anode include graphite and other forms of carbon, silicon and silicon oxide, tin and tin alloys.

Certain anode materials have particular advantages. While graphite having a theoretical specific capacity of 372 mAh·g⁻¹ is most widely used in lithium-ion batteries, anode materials with high specific capacity, for example high specific capacities ranging about 900 mAh·g⁻¹ to about 4,200 mAh·g⁻¹, are of growing interest. For example, silicon has the highest known theoretical capacity for lithium (e.g., about 4,200 mAh·g⁻¹), making it an appealing materials for rechargeable lithium ion batteries. However, anodes comprising silicon may suffer from drawbacks. For example, excessive volumetric expansion and contraction (e.g., about 400% for silicon as compared to about 60% for graphite) during successive charging and discharging cycles. Such volumetric changes may lead to fatigue cracking and decrepitation of the electroactive material, as well as pulverization of material particles, which in turn may cause a loss of electrical contact between the silicon-containing electroactive material and the rest of the battery cell resulting in poor capacity retention and premature cell failure. This is especially true at electrode loading levels required for the application of silicon-containing electrodes in high-energy lithium-ion batteries, such as those used in transportation applications.

Accordingly, it would be desirable to develop high performance electrode materials, particularly comprising silicon and other electroactive materials that undergo significant volumetric changes during lithium ion cycling, and methods for preparing such high performance electrodes materials for use in high energy and high power lithium ion batteries, which overcome and/or accommodate the such volumetric changes, especially for vehicle applications.

### SUMMARY

This section provides a general summary of the disclosure, and is not a comprehensive disclosure of its full scope or all of its features.

The present disclosure relates to an electrochemical cell having an elastic binding polymer that improves long-term performance of the electrochemical cell, particularly when the electrochemical cell includes an electroactive material that undergoes volumetric expansion and contraction during cycling of the electrochemical cell (such as, silicon-containing electroactive materials). The electrochemical cell can include the elastic binding polymer as an electrode additive and/or a coating layer disposed adjacent to an exposed surface of an electrode that includes an electroactive material that undergoes volumetric expansion and contraction and/or a gel layer disposed adjacent to an electrode that includes an electroactive material that undergoes volumetric expansion and contraction.

In various aspects, the present disclosure provides an electrochemical cell that cycles lithium ions. The electrochemical cell may include an electrode and an elastic interlayer disposed adjacent to an exposed surface of the electrode. The electrode may include an electroactive material that undergoes volumetric expansion and contraction during cycling of the electrochemical cell. The elastic interlayer may include an elastic binding polymer. The elastic binding polymer may include one or more alginates and at least one crosslinker.

In one aspect, the one or more alginates may include (a) an alginate salt selected from the group consisting of: lithium alginate, sodium alginate, potassium alginate, ammonium alginate, and combinations thereof; (b) a grafted alginate selected from the group consisting of: polyacrylamide-g alginate, polyacrylate-g-alginate, polyvinylpyrrolidone-g-alginate, dodecylamide-g alginate, and combinations thereof; (c) an alginate derivative including an alginate backbone having been subjected to at least one of oxidation, reductive-amination sulfation, coupling of cyclodextrin of hydroxyl groups and esterification, Ugi reactions, and amidation of carboxyl groups; and (d) any combination thereof.

In one aspect, each crosslinker includes a multi-valence cation and an anion. The multi-valence cation may be selected from the group consisting of: Ca²⁺, Mg²⁺, Al³⁺, Zn²⁺, Fe²⁺, Fe³⁺, and combinations thereof. The anion may be selected from the group consisting of: Cl⁻, SO₄²⁻, NO₃⁻, and combinations thereof.

In one aspect, the elastic binding polymer includes greater than or equal to about 95 wt. % to less than or equal to about 99.99 wt. % of the one or more alginates, and greater than or equal to about 0.01 wt. % to less than or equal to about 5 wt. % of the at least one crosslinker.

In one aspect, the electrode may further include greater than 0 wt. % to less than or equal to about 20 wt. % of the elastic binding polymer.

In one aspect, the elastic interlayer may have a thickness less than or equal to about 50 μm. The electrode may have a thickness greater than or equal to about 1 μm to less than or equal to about 1000 μm.

In one aspect, the elastic interlayer may be a gel layer having a thickness less than or equal to about 10 μm.

In one aspect, the electroactive material may be a silicon-containing electroactive material.

In one aspect, the exposed surface may be a first exposed surface and the electrochemical cell may further include a current collector disposed adjacent a second exposed surface of the electrode. The second exposed surface may be substantially parallel with the first exposed surface.

In various other aspect, the present disclosure provides another example electrochemical cell that cycles lithium ions. The electrochemical cell may include an electrode the includes an electroactive material that undergoes volumetric expansion and contraction during cycling of the electrochemical cell and an elastic binding polymer. The elastic binding polymer may include one or more alginates and at least one crosslinker.

In one aspect, the one or more alginates may include (a) an alginate salt selected from the group consisting of: lithium alginate, sodium alginate, potassium alginate, ammonium alginate, and combinations thereof; (b) a grafted alginate selected from the group consisting of: polyacrylamide-g alginate, polyacrylate-g-alginate, polyvinylpyrrolidone-g-alginate, dodecylamide-g alginate, and combinations thereof: (c) an alginate derivative comprising an alginate backbone having been subjected to at least one of oxidation, reductive-amination sulfation, coupling of cyclodextrin of hydroxyl groups and esterification, Ugi reactions, and amidation of carboxyl groups; or (d) any combination thereof.

In one aspect, each crosslinker includes a multi-valence cation and an anion. The multi-valence cation may be selected from the group consisting of: Ca²⁺, Mg²⁺, Al³⁺, Zn²⁺, Fe²⁺, Fe³⁺, and combinations thereof. The anion may be selected from the group consisting of: Cl⁻, SO₄²⁻, NO₃⁻, and combinations thereof.

In one aspect, the elastic binding polymer may include greater than or equal to about 95 wt. % to less than or equal to about 99.99 wt. % of the one or more alginates, and greater than or equal to about 0.01 wt. % to less than or equal to about 5 wt. % of the at least one crosslinker.

In one aspect, the electrochemical cell may further include an elastic interlayer disposed adjacent to an exposed surface of the electrode. The elastic interlayer may be a gel layer including the elastic binding polymer.

In one aspect, the elastic interlayer may have a thickness less than or equal to about 50 μm. The electrode may have a thickness greater than or equal to about 1 μm to less than or equal to about 1000 μm.

In various aspects, the present disclosure provides another example electrochemical cell that cycles lithium ions. The electrochemical cell may include a negative electrode, a current collector disposed adjacent to a first exposed surface of the negative electrode, and an elastic interlayer disposed adjacent to a second exposed surface of the negative electrode. The second exposed surface of the negative electrode may substantially parallel with the first exposed surface of the negative electrode. The negative electrode may include a negative silicon-containing electroactive material. The negative electrode may have a thickness greater than or equal to about 1 μm to less than or equal to about 1000 μm. The elastic interlayer may have a thickness less than or equal to about 50 μm. The elastic interlayer may be a gel layer that includes an elastic binding polymer. The elastic binding polymer may include one or more alginates and at least one crosslinker.

In one aspect, the one or more alginates may include (a) an alginate salt selected from the group consisting of: lithium alginate, sodium alginate, potassium alginate, ammonium alginate, and combinations thereof; (b) a grafted alginate selected from the group consisting of: polyacrylamide-g alginate, poly acrylate-g-alginate, polyvinylpyrrolidone-g-alginate, dodecylamide-g alginate, and combinations thereof; (c) an alginate derivatives comprising an alginate backbone having been subjected to at least one of oxidation, reductive-amination sulfation, coupling of cyclodextrin of hydroxyl groups and esterification, Ugi reactions, and amidation of carboxyl groups; or (d) any combination thereof.

In one aspect, each crosslinker includes a multi-valence cation and an anion. The multi-valence cation may be selected from the group consisting of: Ca²⁺, Mg²⁺, Al³⁺, Zn²⁺, Fe²⁺, Fe³⁺, and combinations thereof. The anion may be selected from the group consisting of: Cl⁻, SO₄²⁻, NO₃⁻, and combinations thereof.

In one aspect, the elastic binding polymer may include greater than or equal to about 95 wt. % to less than or equal to about 99.99 wt. % of the one or more alginates, and greater than or equal to about 0.01 wt. % to less than or equal to about 5 wt. % of the at least one crosslinker.

In one aspect, the negative electrode may further include greater than 0 wt. % to less than or equal to about 20 wt. % of the elastic binding polymer.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell having an elastic interlayer in accordance with certain aspects of the present disclosure;

FIG. 2 is a schematic of an example electrochemical battery cell having an negative electrode that includes an elastic binding polymer in accordance with certain aspects of the present disclosure; and

FIG. 3 is a schematic of an example electrochemical battery cell having both a negative electrode that includes an elastic binding polymer and an elastic interlayer in accordance with certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to an electrochemical cell having an elastic binding polymer that improves long-term performance of the electrochemical cell, particularly when the electrochemical cell includes an electroactive material that undergoes volumetric expansion and contraction during cycling of the electrochemical cell (such as, silicon-containing electroactive materials). The electrochemical cell can include the elastic binding polymer as an electrode additive and/or an elastic interface coating or layer disposed on an exposed surface of an electrode. By “elastic” it is meant that the electrode additive and/or interface coating or layer may accommodate the volumetric expansion and contraction of the electroactive materials (e.g., silicon-containing electroactive materials) in the electrode (e.g., negative electrode) during long-term cycling (e.g., greater than 200 lithiation-delithiation cycles) of the electrochemical cell without damage, fracture, and substantial consumption of the electrolyte.

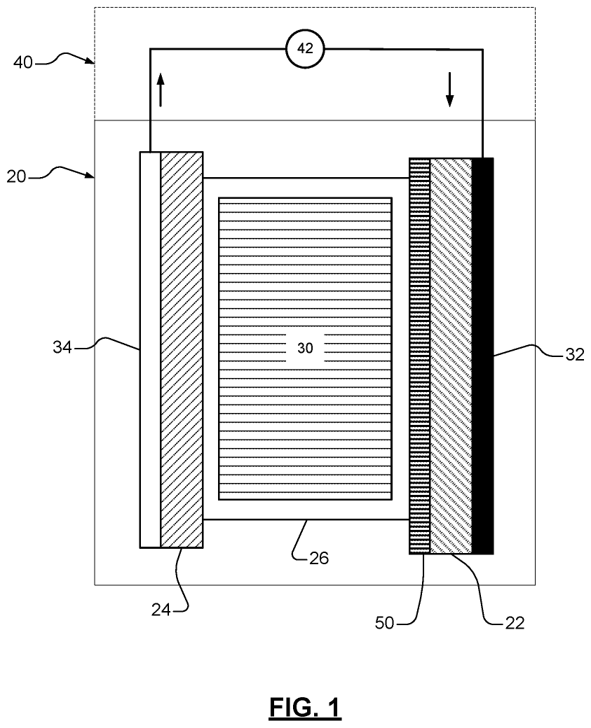

A typical lithium-ion battery (e.g., electrochemical cell that cycles lithium ions) includes a first electrode (such as, a positive electrode or cathode) opposing a second electrode (such as, a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions (or sodium ions in the case of sodium-ion batteries, and the like) and may be in liquid, gel, or solid form. For example, exemplary and schematic illustrations of electrochemical cells (also referred to as the batteries) are shown in FIGS. 1-3.

Such cells are used in vehicle or automotive transportation applications (e.g., motorcycles, boats, tractors, buses, motorcycles, mobile homes, campers, and tanks). However, the current technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single cathode and a single anode, the skilled artisan will recognize that the current teachings extend to various other configurations, including those having one or more cathodes and one or more anodes, as well as various current collectors with electroactive layers disposed on or adjacent to one or more surfaces thereof.

As illustrated in FIG. 1, the battery 20 includes a negative electrode 22 (e.g., anode), a positive electrode 24 (e.g., cathode), and a separator 26 disposed between the two electrodes 22, 24. The battery 20 may also include an elastic interlayer 50 disposed between the negative electrode 22 and the separator 26. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22, the positive electrode 24, and the elastic interlayer 50. In certain variations, the separator 26 may be formed by a solid-state electrolyte 30. For example, the separator 26 may be defined by a plurality of solid-state electrolyte particles (not shown).

A negative electrode current collector 32 may be positioned at or near the negative electrode 22, and a positive electrode current collector 34 may be positioned at or near the positive electrode 24. The negative electrode current collector 32 may be a metal foil, metal grid or screen, or expanded metal comprising copper or any other appropriate electrically conductive material known to those of skill in the art. The positive electrode current collector 34 may be a metal foil, metal grid or screen, or expanded metal comprising aluminum or any other appropriate electrically conductive material known to those of skill in the art. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions that are also produced at the negative electrode 22 are concurrently transferred through the electrolyte 30 contained in the separator 26 towards the positive electrode 24. The electrons flow through the external circuit 40 and the lithium ions migrate across the separator 26 containing the electrolyte 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source (e.g., charging device) to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back towards the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the current technology also apply to solid-state batteries that include solid-state electrolytes (and solid-state electroactive particles) that may have a different design, as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be e fully or partially powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain variations, the electrolyte 30 may be an ionic electrolyte having a comparatively high viscosity. In certain aspects, the electrolyte 30 may be a non-aqueous liquid electrolyte solution (e.g., >1M) that includes a lithium salt dissolved in an organic solvent or a mixture of organic solvents. In certain instances, the electrolyte 30 may also include one or more additives, such as vinylene carbonate (VC), butylene carbonate (BC), fluoroethylene carbonate (FEC), and the like. Numerous conventional non-aqueous liquid electrolyte solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. The lithium salts may include one or more cations coupled with one or more anions. The cations may be selected from Li⁺, Na⁺, K⁺, Al³⁺, Mg²⁺, and the like. The anions may be selected from PF⁶⁻, BF⁴⁻, TFSI⁻, FSI⁻, CF₃SO₃₋, (C₂F₅S₂O₂)N⁻, and the like. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates (arbonates), such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26. The separator 26 may have a thickness greater than or equal to about 1 μm to less than or equal to about 50 μm, and in certain instances, optionally greater than or equal to about 1 μm to less than or equal to about 20 μm.

In various aspects, the porous separator 26 and the electrolyte 30 in FIG. 1 may be replaced with a solid-state electrolyte (“SSE”) (not shown) that functions as both an electrolyte and a separator. The solid-state electrolyte may be disposed between the positive electrode 24 and negative electrode 22. The solid-state electrolyte facilitates transfer of lithium ions, while mechanically separating and providing electrical insulation between the negative and positive electrodes 22, 24. By way of non-limiting example, solid-state electrolytes may include a plurality of solid-state electrolyte particles such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The solid-state electrolyte particles may be nanometer sized oxide-based solid-state electrolyte particles. In still other variations, the porous separator 26 and the electrolyte 30 in FIG. 1 may be replaced with a gel electrolyte.

The positive electrode 24 may be formed from a lithium-based active material that is capable of undergoing lithium intercalation and deintercalation, alloying and dealloying, or plating and stripping, while functioning as the positive terminal of the battery 20. For example, the positive electrode 24 can be defined by a plurality of electroactive material particles (not shown) disposed in one or more layers so as to define the three-dimensional structure of the positive electrode 24. The electrolyte 30 may be introduced, for example after cell assembly, and contained within pores (not shown) of the positive electrode 24. For example, the positive electrode 24 may include a plurality of electrolyte particles (not shown). The positive electrode 24 (including the one or more layers) may have a thickness greater than or equal to about 1 μm to less than or equal to about 1000 μm.

One exemplary common class of known electroactive materials that can be used to form the positive electrode 24 is layered lithium transitional metal oxides. For example, in certain aspects, the positive electrode 24 may comprise one or more materials having a spinel structure, such as lithium manganese oxide (Li₍₁₊ₓ₎Mn₂O₄, where 0.1≤x≤1), lithium manganese nickel oxide (LiMn₍₂₋ₓ₎NiₓO₄, where 0≤x≤0.5) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co₀.33O₂), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄), lithium manganese-iron phosphate (LiMn₂₋ₓFeₓPO₄, where 0<x<0.3), or lithium iron fluorophosphate (Li₂FePO₄F).

In certain other aspects, the positive electrode 24 may include one or more high-voltage oxides (such as, LiNi_{0.5}Mn_{1.5}O₄, LiFePO₄), one or more rock salt layered oxides (such as, LiCoO₂, LiNiₓMn_{y}Co_{1-x-y}O₂ (where 0≤x≤1, 0≤y≤1), LiNiₓCO_{y}Al_{1-x-y}O₂ (where 0≤x≤1, 0≤y≤1), LiNiₓMn₁₋ₓO₂ (where 0≤x≤1), Li₁₊ₓMO₂ (where 0≤x≤2 and where M refers to metal elements selected from Mn, Ni, and the like), one or more polyanions (such as, LiV₂(PO₄)₃), and other like lithium transition metal oxides. The positive electroactive material may also be surface coated and/or doped. For example, the positive electroactive material may include LiNbO₃-coated LiNi_{0.5}Mn_{1.5}O₄.

In each instance, the positive electroactive materials may be optionally intermingled with an electronically conducting material that provides an electron conduction path and/or at least one polymeric binder material that improves the structural integrity of the electrode. For example, the positive electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, graphene oxide, and the like. Examples of a conductive polymer include polyaniline, polythiophene, polyacetylene, polypyrrole, and the like. In certain aspects, mixtures of the conductive materials may be used.

For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive electroactive material; greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 5 wt. % to less than or equal to about 15 wt. %, of one or more binders. In certain instances, the positive electrode 24 may further includes greater 0 wt. % to less than or equal to about 70 wt. % of solid-state electrolyte particles.

The negative electrode 22 comprises a lithium host material that is capable of functioning as a negative terminal of a lithium-ion battery. For example, the negative electrode 22 may comprise a lithium host material (e.g., negative electroactive material) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, the negative electrode 22 may include a plurality of electrolyte particles (not shown). The negative electrode 22 (including the one or more layers) may have a thickness greater than or equal to about 1 μm to less than or equal to about 1000 μm.

The negative electrode 22 may include a negative electroactive material that comprises lithium, such as, for example, lithium metal.

In certain variations, the negative electrode 22 is a film or layer formed of lithium metal or an alloy of lithium. Other materials can also be used to form the negative electrode 22, including, for example, carbonaceous materials (such as graphite, hard carbon, soft carbon), lithium-silicon and silicon containing binary and ternary alloys and/or tin-containing alloys (such as Si, SiOₓ (where 0≤x≤2), Si/C, SiOₓ/C (where 0≤x≤2), Si—Sn, SiSnFe, SiSnAl, SiFeCo, SnO₂, and the like), and/or metal oxides (such as Fe₃O₄). In certain alternative embodiments, lithium-titanium anode materials are contemplated, such as Li₄₊ₓTi₅O₁₂, where 0≤x≤3, including lithium titanate (Li₄Ti₅O₁₂) (LTO). Thus, negative electroactive materials for the negative electrode 22 may be selected from lithium, graphite, hard carbon, soft carbon, silicon, silicon-containing alloys, tin-containing alloys, metal oxides, and the like.

In certain variations, the negative electroactive material in the negative electrode 22 may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders such as bare alginate salts, poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, graphene oxide, and the like. Examples of a conductive polymer include polyaniline, polythiophene, polyacetylene, polypyrrole, and the like.

For example, the negative electrode 22 may include greater than or equal to about 30 wt. % to less than or equal to about 99.5 wt. %, and in certain aspects, optionally greater than or equal to about 50 wt. % to less than or equal to about 95 wt. %, of the negative electroactive material; greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 5 wt. % to less than or equal to about 15 wt. %, of one or more binders. In certain instances, the negative electrode 22 may further includes greater 0 wt. % to less than or equal to about 70 wt. % of solid-state electrolyte particles.

In various aspects, an elastic interlayer 50 may be positioned at or near the negative electrode 22. For example, as illustrated, the elastic interlayer 50 may be disposed at or near a surface of the negative electrode 22 that opposes the negative electrode current collector 32. The elastic interlayer 50 may be disposed between the negative electrode 22 and the separator 26 (or solid-state electrolyte). The elastic interlayer 50 may have a thickness less than or equal to about 50 μm, and in certain aspects, optionally less than or equal to about 20 μm.

The elastic characteristic of the interlayer 50, as well as the improved mechanical or tensile strength, for examples as provided by crosslinking structures resulting from the abundance of hydroxyl and carboxyl groups of low-cost alginates and derivatives, can provide protection against undesired material pulverization and degradation that may arise during volumetric expansion, such as may result when the negative electrode 22 includes silicon and/or other electroactive materials that undergo significant volumetric changes during lithium ion cycling, as discussed above. By “elastic,” it is meant that the interlayer layer 50 may accommodate the volumetric expansion and contraction of the electroactive materials (e.g., silicon-containing electroactive materials) in the negative electrode 22 during long-term cycling (e.g., greater than 200 lithiation-delithiation cycles) of the electrochemical cell 20 without damage, fracture, and substantial consumption of the electrolyte.

The elastic interlayer 50 may be a gel layer having an ionic conductivity larger than 10⁻⁴ mS/cm, and in certain aspects, optionally larger than 10⁻³ mS/cm. The elastic interlayer 50 includes an elastic binding polymer. The elastic binding polymer may be prepared by crosslinking one or more alginates or derivatives. For example, the elastic binding polymer may comprise one or more polymers and at least one crosslinker. More specifically, the elastic binding polymer comprises one or more alginates and at least one crosslinker. The elastic binding polymer may immobilize liquid electrolyte so as to form the gel layer. For example, as discussed in further detail below, the gel layer may be formed by disposing (for example, pre-coating) an elastic interlayer precursor that includes the elastic binding polymer onto a surface of the negative electrode 22 and/or incorporating a free-standing polymer interlayer comprising the elastic binding polymer into the cell 20 stack. In each instance, the elastic binding polymer will immobilize liquid electrolyte (in situ) after an electrolyte filling process so as to form the ionic conductive elastic interlayer 50. For example, the liquid electrolyte may be immobilized by functional groups, such as carboxyl and hydroxyl groups, of the elastic binding polymer.

The one or more alginates may include an alginate salt (such as, lithium alginate, sodium alginate, potassium alginate, ammonium alginate, and the like), a grafted alginate coupled with one of lithium, sodium, potassium ammonium cation, and the like (such as, polyacrylamide-g alginate, sodium polyacrylate-g-alginate, polyvinylpyrrolidone-g-alginate, dodecylamide-g alginate, and the like), and/or an alginate derivative coupled with one of lithium, sodium, potassium ammonium cation, and the like (such as, oxidation, reductive-amination sulfation, coupling of cyclodextrin of hydroxyl groups and esterification, Ugi reactions, amidation of carboxyl groups on an alginate backbone). Each crosslinker may include a multi-valence cation and an anion. The multi-valence cation may be selected from Ca²⁺, Mg²⁺, Al³⁺, Zn²⁺, Fe²⁺, Fe³⁺, and the like. The anion may include Cl⁻, SO₄²⁻, NO₃⁻, and the like.

In various aspects, the present disclosure provide methods for forming elastic interlayers, such as elastic interlayer 50 illustrated in FIG. 1. For example, in one aspect, a method is provided which includes preparing an elastic interlayer precursor solution and disposing or pre-coating the solution onto an exposed surface of a negative electrode followed by drying process. The elastic interlayer precursor solution may disperse an elastic binding polymer in solution. The elastic binding polymer may include one or more polymers and at least one crosslinker. More specifically, elastic binding polymer comprises one or more alginates and at least one crosslinker. The elastic binding polymer may include greater than or equal to about 95 wt. % to less than or equal to about 99.99 wt. %, and in certain aspects, optionally greater than or equal to about 95 wt. % to less than or equal to about 98 wt. % of the one or more alginates; and greater than or equal to about 0.01 wt. % to less than or equal to about 5 wt. %, and in certain aspects, optionally greater than or equal to about 2 wt. % to less than or equal to about 5 wt. % of the at least one crosslinker.

The elastic binding polymer may be dispersed in an aqueous solution, such as water. The elastic interlayer precursor solution may include less than or equal to about 3 wt. %, and in certain aspects, optionally less than or equal to about 2 wt. % of the elastic binding polymer. If the interlayer precursor solution includes an amount of the elastic binding polymer that is greater than about 3 wt. %, the viscosity of the elastic interlayer precursor solution may be too large so as to sufficiently coat the negative electrode. Upon introduction of the liquid electrolyte into the cell including the coated anode, the elastic binding polymer will immobilize the liquid electrolyte (in situ) so as to form an elastic interlayer. For example, the liquid electrolyte may be immobilized by functional groups, such as carboxyl and hydroxyl groups, of the elastic binding polymer.

In other aspects, a method is provided which includes preparing an elastic interlayer precursor solution and disposing or pre-coating the solution onto an exposed surface of a substrate (such as, glass, PET, and the like). A free-standing polymer interlayer may be obtained after drying the elastic interlayer precursor solution. The free-standing polymer interlayer may be a porous membrane having a porosity greater than 0 vol. % to less than or equal to or equal to about 70 vol. %, and in certain aspects, optionally greater than or equal to about 10 vol. % to than or equal to about 30 vol. %.

The elastic interlayer precursor solution may disperse an elastic binding polymer in solution. The elastic binding polymer may include one or more polymers and at least one crosslinker. More specifically, elastic binding polymer comprises one or more alginates and at least one crosslinker. The elastic binding polymer may include greater than or equal to about 95 wt. % to less than or equal to about 99.99 wt. %, and in certain aspects, optionally greater than or equal to about 95 wt. % to less than or equal to about 98 wt. % of the one or more alginates; and greater than or equal to about 0.01 wt. % to less than or equal to about 5 wt. %, and in certain aspects, optionally greater than or equal to about 2 wt. % to less than or equal to about 5 wt. % of the at least one crosslinker.

The elastic binding polymer may be dispersed in an aqueous solution, such as water. The elastic interlayer precursor solution may include less than or equal to about 3 wt. %, and in certain aspects, optionally less than or equal to about 2 wt. % of the elastic binding polymer. If the interlayer precursor solution includes an amount of the elastic binding polymer that is greater than about 3 wt. %, the viscosity of the elastic interlayer precursor solution may be too large so as to sufficiently coat the free-standing polymer interlayer. The pre-coated free-standing polymer interlayer may be incorporated into the cell stack and upon introduction of the liquid electrolyte, the elastic interlayer precursor will immobilize the liquid electrolyte (in situ) so as to form an elastic interlayer. For example, the liquid electrolyte may be immobilized by functional groups, such as carboxyl and hydroxyl groups, of the elastic binding polymer.

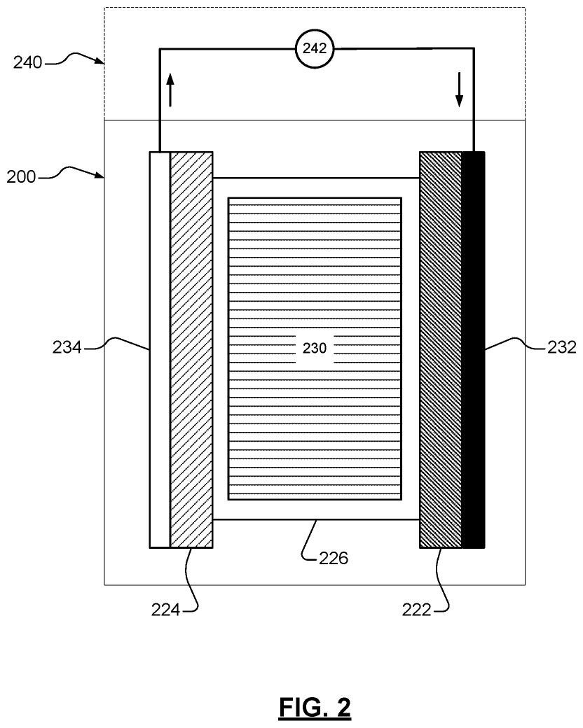

Another exemplary and schematic illustration of an electrochemical cell (also referred to as the battery) 200 is shown in FIG. 2. Similar to battery 20 illustrated in FIG. 1, battery 200 includes a negative electrode 222 (e.g., anode), a positive electrode 224 (e.g., cathode), and a separator 226 disposed between the two electrodes 222, 224. In various aspects, the separator 226 comprises an electrolyte 230 that may, in certain aspects, also be present in the negative electrode 222 and positive electrode 224. A negative electrode current collector 232 may be positioned at or near the negative electrode 222, and a positive electrode current collector 234 may be positioned at or near the positive electrode 224. The negative electrode current collector 232 and the positive electrode current collector 234 respectively collect and move free electrons to and from an external circuit 240. For example, an interruptible external circuit 240 and a load device 212 may connect the negative electrode 222 (through the negative electrode current collector 232) and the positive electrode 224 (through the positive electrode current collector 234).

Unlike battery 20, however, battery 200 illustrated in FIG. 2 does not have a distinct elastic interlayer. Instead, in the instance of battery 200, the negative electrode 222 includes an elastic additive. The negative electrode 222 may include greater than or equal to about 30 wt. % to less than or equal to about 99.5 wt. %, and in certain aspects, optionally greater than or equal to about 50 wt. % to less than or equal to about 95 wt. %, of a negative electroactive material; and greater than 0 wt. % to less than or equal to about 20 wt. %, optionally greater than 0 wt. % to less than or equal to about 10 wt. %, and in certain aspects, optionally greater than e0 wt. % to less than or equal to about 5 wt. %, of the elastic additive. The elastic characteristic of the negative electrode 222 can provide protection against undesired material pulverization and degradation that may arise during volumetric expansion, such as may result when the negative electrode 322 includes silicon and/or other electroactive materials that undergo significant volumetric changes during lithium ion cycling, as discussed above.

The elastic additive may include one or more alginates and at least one crosslinker. For example, the elastic additive may include greater than or equal to about 95 wt. % to less than or equal to about 99.99 wt. %, and in certain aspects, optionally greater than or equal to about 95 wt. % to less than or equal to about 98 wt. % of the one or more alginates; and greater than or equal to about 0.01 wt. % to less than or equal to about 5 wt. %, and in certain aspects, optionally greater than or equal to about 2 wt. % to less than or equal to about 5 wt. % of the at least one crosslinker.

The one or more alginates may include an alginate salt (such as, lithium alginate, sodium alginate, potassium alginate, ammonium alginate, and the like), a grafted alginate coupled with one of lithium, sodium, potassium ammonium cation, and the like (such as, polyacrylamide-g alginate, sodium polyacrylate-g-alginate, polyvinylpyrrolidone-g-alginate, dodecylamide-g alginate, and the like), and/or an alginate derivative coupled with one of lithium, sodium, potassium ammonium cation, and the like (such as, oxidation, reductive-amination sulfation, coupling of cyclodextrin of hydroxyl groups and esterification, Ugi reactions, amidation of carboxyl groups on an alginate backbone). Each crosslinker may include a multi-valence cation and an anion. The multi-valence cation may be selected from Ca²⁺, Mg²⁺, Al³⁺, Zn²⁺, Fe²⁺, Fe³⁺, and the like. The anion may include SO₄²⁻, NO₃⁻, and the like.

In certain aspects, like negative electrode 22 illustrated in FIG. 1, the negative electrode 222 may optionally include one or more electrically conductive materials and/or at least one polymeric binder material. However, negative electrode 222, as illustrated in FIG. 2, includes a total amount of binders, including the elastic binding polymer and the at least one polymeric binder material (e.g., sodium carboxymethyl cellulose (CMC), poly(tetrafluoroethylene) (PTFE)), of less than or equal to about 20 wt. %, optionally less than or equal to about 10 wt. %, and in certain aspects, optionally less than or equal to about 5 wt. %.

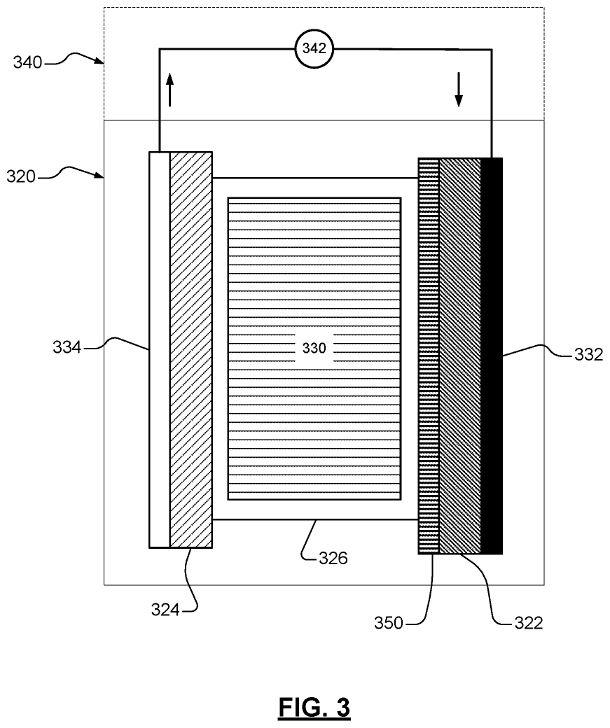

Another exemplary and schematic illustration of an electrochemical cell (also referred to as the battery) 300 is shown in FIG. 3. Similar to battery 20 illustrated in FIG. 1, battery 300 includes a negative electrode 322 (e.g., anode), a positive electrode 324 (e.g., cathode), and a separator 326 disposed between the two electrodes 322, 324. The battery 320 may also include an elastic interlayer 350 disposed between the negative electrode 322 and the separator 326. In various aspects, the separator 326 comprises an electrolyte 330 that may, in certain aspects, also be present in the negative electrode 322, positive electrode 324, and the elastic interlayer 350. A negative electrode current collector 332 may be positioned at or near the negative electrode 322, and a positive electrode current collector 334 may be positioned at or near the positive electrode 324. The negative electrode current collector 332 and the positive electrode current collector 334 respectively collect and move free electrons to and from an external circuit 340. For example, an interruptible external circuit 340 and a load device 312 may connect the negative electrode 322 (through the negative electrode current collector 332) and the positive electrode 324 (through the positive electrode current collector 334).

The elastic interlayer 350 may be positioned at or near the negative electrode 322. For example, as illustrated, the elastic interlayer 350 may be disposed at or near a surface of the negative electrode 322 that opposes the negative electrode current collector 332. The elastic interlayer 350 may be disposed between the negative electrode 322 and the separator 326 (or solid-state electrolyte). The elastic interlayer 350 may have a thickness less than or equal to about 50 μm, and in certain aspects, optionally less than or equal to about 20 μm.

The elastic interlayer 350 may be a gel layer that includes one or more alginates and at least one crosslinker. For example, the elastic interlayer 350 may include greater than or equal to about 95 wt. % to less than or equal to about 99.99 wt. %, and in certain aspects, optionally greater than or equal to about 95 wt. % to less than or equal to about 98 wt. % of the one or more alginates; and greater than or equal to about 0.01 wt. % to less than or equal to about 5 wt. %, and in certain aspects, optionally greater than or equal to about 2 wt. % to less than or equal to about 5 wt. % of the at least one crosslinker.

In certain variations, the one or more alginates may include an alginate salt (such as, lithium alginate, sodium alginate, potassium alginate, ammonium alginate, and the like), a grafted alginates coupled with one of lithium, sodium, potassium ammonium cation, and the like (such as, polyacrylamide-g alginate, sodium polyacrylate-g-alginate, polyvinylpyrrolidone-g-alginate, dodecylamide-g alginate, and the like), and/or an alginate derivatives coupled with one of lithium, sodium, potassium ammonium cation, and the like (such as, oxidation, reductive-amination sulfation, coupling of cyclodextrin of hydroxyl groups and esterification, Ugi reactions, amidation of carboxyl groups on an alginate backbone). Each crosslinker may include a multi-valence cation and an anion. The multi-valence cation may be selected from Ca²⁺, Mg²⁺, Al³⁺, Zn²⁺, Fe²⁺, Fe³⁺, and the like. The anion may include Cl⁻, SO₄²⁻, NO₃⁻, and the like.

Similar, to battery 200 illustrated in FIG. 2, the negative electrode 322 illustrated in FIG. 3, may include an elastic additive. For example, the negative electrode 322 may include greater than or equal to about 30 wt. % to less than or equal to about 99.5 wt. %, and in certain aspects, optionally greater than or equal to about 50 wt. % to less than or equal to about 95 wt. %, of a negative electroactive material; and greater than 0 wt. % to less than or equal to about 20 wt. %, optionally greater than 0 wt. % to less than or equal to about 10 wt. %, and in certain aspects, optionally greater than 0 wt. % to less than or equal to about 5 wt. %, of the elastic additive.

The elastic additive may include at least one polymer and at least one crosslinker. For example, the elastic additive may include greater than or equal to about 95 wt. % to less than or equal to about 99.99 wt. %, and in certain aspects, optionally greater than or equal to about 95 wt. % to less than or equal to about 98 wt. % of the one or more alginates; and greater than or equal to about 0.01 wt. % to less than or equal to about 5 wt. %, and in certain aspects, optionally greater than or equal to about 2 wt. % to less than or equal to about 5 wt. % of the at least one crosslinker.

The one or more alginates may include an alginate salt (such as, lithium alginate, sodium alginate, potassium alginate, ammonium alginate, and the like), a grafted alginate coupled with one of lithium, sodium, potassium ammonium cation, and the like (such as, polyacrylamide-g alginate, sodium polyacrylate-g-alginate, polyvinylpyrrolidone-g-alginate, dodecylamide-g alginate, and the like), and/or an alginate derivative coupled with one of lithium, sodium, potassium ammonium cation, and the like (such as, oxidation, reductive-amination sulfation, coupling of cyclodextrin of hydroxyl groups and esterification, Ugi reactions, amidation of carboxyl groups on an alginate backbone). Each crosslinker may include a multi-valence cation and an anion. The multi-valence cation may be selected from Ca²⁺, Mg²⁺, Al³⁺, Zn²⁺, Fe²⁺, Fe³⁺, and the like. The anion may include Cl⁻, SO₄²⁻, NO₃⁻, and the like.

In certain aspects, like negative electrode 22 illustrated in FIG. 1, the negative electrode 322 may optionally include one or more electrically conductive materials and/or at least one polymeric binder material. However, negative electrode 322, as illustrated in FIG. 3, includes a total amount of binders, including the elastic binding polymer and the at least one polymeric binder material (e.g., sodium carboxymethyl cellulose (CMC), poly(tetrafluoroethylene) (PTFE)), of less than or equal to about 20 wt. %, optionally less than or equal to about 10 wt. %, and in certain aspects, optionally less than or equal to about 5 wt. %.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions comprising:
an electrode comprising an electroactive material that undergoes volumetric expansion and contraction during cycling of the electrochemical cell; and
an elastic interlayer disposed adjacent to an exposed surface of the electrode, wherein the elastic interlayer comprises an elastic binding polymer, wherein the elastic binding polymer comprises one or more alginates and at least one crosslinker.

2. The electrochemical cell of claim 1, wherein the one or more alginates comprise:
(a) an alginate salt selected from the group consisting of: lithium alginate, sodium alginate, potassium alginate, ammonium alginate, and combinations thereof;
(b) a grafted alginate selected from the group consisting of: polyacrylamide-g alginate, polyacrylate-g-alginate, polyvinylpyrrolidone-g-alginate, dodecylamide-g alginate, and combinations thereof;
(c) an alginate derivatives comprising an alginate backbone having been subjected to at least one of oxidation, reductive-amination sulfation, coupling of cyclodextrin of hydroxyl groups and esterification, Ugi reactions, and amidation of carboxyl groups; or
(d) any combination thereof.

3. The electrochemical cell of claim 1, wherein each crosslinker comprises a multi-valence cation selected from the group consisting of: Ca²⁺, Mg²⁺, Al³⁺, Zn²⁺, Fe²⁺, Fe³⁺, and combinations thereof, and
an anion selected from the group consisting of: Cl⁻, SO₄²⁻, NO₃⁻, and combinations thereof.

4. The electrochemical cell of claim 1, wherein the elastic binding polymer comprises:
greater than or equal to about 95 wt. % to less than or equal to about 99.99 wt. % of the one or more alginates, and
greater than or equal to about 0.01 wt. % to less than or equal to about 5 wt. % of the at least one crosslinker.

5. The electrochemical cell of claim 1, wherein the electrode further comprises greater than 0 wt. % to less than or equal to about 20 wt. % of the elastic binding polymer.

6. The electrochemical cell of claim 1, wherein the elastic interlayer has a thickness less than or equal to about 50 μm and the electrode has a thickness greater than or equal to about 1 μm to less than or equal to about 1000 μm.

7. The electrochemical cell of claim 1, wherein the elastic interlayer is a gel layer having a thickness less than or equal to about 10 μm.

8. The electrochemical cell of claim 1, wherein the electroactive material is a silicon-containing electroactive material.

9. The electrochemical cell of claim 1, wherein the exposed surface is a first exposed surface and the electrochemical cell further comprises a current collector disposed adjacent a second exposed surface of the electrode, wherein the second exposed surface is substantially parallel with the first exposed surface.

10. An electrochemical cell that cycles lithium ions comprising:
an electrode comprising:
an electroactive material that undergoes volumetric expansion and contraction during cycling of the electrochemical cell; and
an elastic binding polymer comprising one or more alginates and at least one crosslinker.

11. The electrochemical cell of claim 10, wherein the one or more alginates comprise:
(a) an alginate salt selected from the group consisting of: lithium alginate, sodium alginate, potassium alginate, ammonium alginate, and combinations thereof;
(b) a grafted alginate selected from the group consisting of: polyacrylamide-g alginate, polyacrylate-g-alginate, polyvinylpyrrolidone-g-alginate, dodecylamide-g alginate, and combinations thereof;
(c) an alginate derivative comprising an alginate backbone having been subjected to at least one of oxidation, reductive-amination sulfation, coupling of cyclodextrin of hydroxyl groups and esterification, Ugi reactions, and amidation of carboxyl groups; or
(d) any combination thereof.

12. The electrochemical cell of claim 10, wherein each crosslinker comprises a multi-valence cation selected from the group consisting of: Ca²⁺, Mg²⁺, Al³⁺, Zn²⁺, Fe²⁺, Fe³⁺, and combinations thereof, and
an anion selected from the group consisting of: Cl⁻, SO₄²⁻, NO₃⁻, and combinations thereof.

13. The electrochemical cell of claim 10, wherein the elastic binding polymer comprises:
greater than or equal to about 95 wt. % to less than or equal to about 99.99 wt. % of the one or more alginates, and
greater than or equal to about 0.01 wt. % to less than or equal to about 5 wt. % of the at least one crosslinker.

14. The electrochemical cell of claim 10, wherein the electrochemical cell further comprises:
an elastic interlayer disposed adjacent to an exposed surface of the electrode, wherein the elastic interlayer is a gel layer comprising the elastic binding polymer.

15. The electrochemical cell of claim 14, wherein the elastic interlayer has a thickness less than or equal to about 50 μm and the electrode has a thickness greater than or equal to about 1 μm to less than or equal to about 1000 μm.

16. An electrochemical cell that cycles lithium ions comprising:
a negative electrode comprising a negative silicon-containing electroactive material and having a thickness greater than or equal to about 1 μm to less than or equal to about 1000 μm;
a current collector disposed adjacent to a first exposed surface of the negative electrode; and
an elastic interlayer having a thickness less than or equal to about 50 μm disposed adjacent to a second exposed surface of the negative electrode, wherein the second exposed surface is substantially parallel with the first exposed surface, the elastic interlayer is a gel layer comprising an elastic binding polymer, and the elastic binding polymer comprises one or more alginates and at least one crosslinker.

17. The electrochemical cell of claim 16, wherein the one or more alginates comprise:
(a) one or more alginate salts selected from the group consisting of: lithium alginate, sodium alginate, potassium alginate, ammonium alginate, and combinations thereof;
(b) one or more grafted alginates selected from the group consisting of: polyacrylamide-g alginate, polyacrylate-g-alginate, polyvinylpyrrolidone-g-alginate, dodecylamide-g alginate, and combinations thereof,
(c) one or more alginate derivatives comprising an alginate backbone having been subjected to at least one of oxidation, reductive-amination sulfation, coupling of cyclodextrin of hydroxyl groups and esterification, Ugi reactions, and amidation of carboxyl groups; and
(d) any combination thereof.

18. The electrochemical cell of claim 16, wherein each crosslinker comprises a multi-valence cation selected from the group consisting of: Ca²⁺, Mg²⁺, Al³⁺, Zn²⁺, Fe²⁺, Fe³⁺, and combinations thereof, and
an anion selected from the group consisting of: Cl⁻, SO₄²⁻, NO₃⁻, and combinations thereof.

19. The electrochemical cell of claim 16, wherein the elastic binding polymer comprises:
greater than or equal to about 95 wt. % to less than or equal to about 99.99 wt. % of the one or more alginates, and
greater than or equal to about 0.01 wt. % to less than or equal to about 5 wt. % of the at least one crosslinker.

20. The electrochemical cell of claim 16, wherein the negative electrode further comprises greater than 0 wt. % to less than or equal to about 20 wt. % of the elastic binding polymer.
